(19) United States
(12) Patent Application Publication
(10) Pub. No.: US 2025/0104154 A1
(43) Pub. Date: Mar. 27, 2025

(54) SYSTEMS AND METHODS OF OPTIMIZING RETIREMENT PLANS

(71) Applicant: Celeritas Technology Holdings, LLC, Wilmington, DE (US)

(72) Inventors: Beau Walker, Irvine, CA (US); Michael Ryabik, Peachtree City, GA (US); Brian Lee Hayes, St.Louis, MO (US); Adam Joseph Recker, Mckinney, TX (US); Christopher Robert Fischer, Clarendon Hills, IL (US); Jonathan Raymond Gussick, Kansas City, MO (US)

(21) Appl. No.: 18/893,875

(22) Filed: Sep. 23, 2024

Related U.S. Application Data
(63) Continuation of application No. 18/471,809, filed on Sep. 21, 2023.

(51) Int. Cl. G06Q 40/06

(52) U.S. Cl. CPC G06Q 40/06

(57) ABSTRACT

Embodiments of the inventive subject matter are directed to retirement plan optimization. By collecting client information, systems and methods of the inventive subject matter are configured to develop scenarios for a user. From those scenarios, multiple simulations can be run. Each scenario features scenario parameters, and each simulation features simulation parameters. Scenario parameters can include ranges of values or a set of different possible values. For a given scenario, many simulations can be run, where each simulation has a corresponding set of simulation parameters, and where each set of simulation parameters features set values for each of the scenario parameters for that scenario. After running multiple simulations for each scenario, high performing simulations can be identified based on a base case performance and based on one or more optimization goals. Once high performing simulations are identified, actionable retirement plans can be developed therefrom.

### PRIORITY

This application claims priority to and is a continuation-in-part of U.S. patent application Ser. No. 18/471,809 filed Sep. 21, 2023. All extrinsic materials identified in this application are incorporated by reference in their entirety.

### FIELD OF THE INVENTION

The field of the invention is retirement plan optimization.

### BACKGROUND

The background description includes information that may be useful in understanding the present invention. It is not an admission that any of the information provided in this application is prior art or relevant to the presently claimed invention, or that any publication specifically or implicitly referenced is prior art.

The financial planning and retirement planning industry is massive and well developed. But the industry remains largely unchanged in how it operates, leaving open ample space for technological advancement. Under current practices, financial planners generally make recommendations and develop financial plans based on their personal experience, industry best practices, and their gut. There is no way to accurately forecast how a plan will perform into the future in part due to the high number of assumptions and variables involved in such a forecast.

Some existing solutions do market forecasting and evaluate future performance based on their estimations of future market performance, but the economy and markets are just one piece of a comprehensive retirement plan. A comprehensive retirement plan must consider additional factors, such as: current and future assets; current and future income; current and future health and life expectancy; relationships and dependents; local economy and cost of living, social security; healthcare; current and future state and federal tax law, and so on.

Factoring in tax and tax policy is particularly important, and when generating a retirement and asset plan, financial planners usually consider one or more factors such as ending total account value, total taxes paid, ending ROTH or non-taxable account value, etc.

These existing planning methods fail to account for different eventualities, including future tax policies and rates, as well as future market and economy performances. A system that optimizes financial planning by accounting for these possibilities in a meaningful way would thus exceed the capabilities of existing processes. Thus, there exists a need in the art for financial planning systems and methods that are capable of quantitatively accounting for a wide variety of different factors including economic and market performance as well as current and future tax policies and rates.

### SUMMARY OF THE INVENTION

The present invention provides systems and methods in directed to developing optimized, actionable retirement plans by running simulations based on client information. In one aspect of the inventive subject matter, a method of developing an optimized retirement plan is contemplated to include the steps of: receiving, at a platform server from a user, client information comprising income data and a client optimization goal; creating a core data frame using the client information; creating a baseline data frame using the core data frame, where the baseline data frame comprises client information and wherein the baseline data frame is used to generate a baseline simulation; creating a comprehensive data frame using the baseline simulation; generating a set of simulations using the comprehensive data frame; using the client optimization goal to evaluate simulation performance by comparing each simulation in the set of simulations to the baseline simulation in view of the client optimization goal; identifying a simulation from the set of simulations as high performing; developing an actionable retirement plan based on the simulation; and sending the actionable retirement plan to the user.

In some embodiments, the method also includes the step of creating utility functions to improve database performance. A comprehensive data frame can include a set of scenario parameters comprising a plurality of possible values, where each simulation of the set of simulations is evaluated year-by-year by executing functions using parameter values for each simulation. The optimization goal can include at least one of: minimized taxes paid, maximized total estate value after tax net of management fees, maximized ending ROTH balance, maximized total cash flow available during a client's lifetime, a maximized account value, and adjusted total return.

In another aspect of the inventive subject matter, a method of developing an optimized retirement plan includes the steps of: initializing a database; defining utility functions to improve database performance; receiving, at a platform server from a user, client information comprising at least one optimization goal; evaluating a base case performance using the client information; defining a set of scenarios, each scenario comprising a set of scenario parameters; defining sets of simulation parameters for each scenario in the set of scenarios, where each set of simulation parameters comprises values for scenario parameters defined using a single set of scenario parameters; generating a set of simulations using each set of simulation parameters; identifying a first simulation in the set of simulations as a nonviable simulation and pruning the nonviable simulation; identifying a second simulation in the set of simulations as a preliminarily high performing simulation and using the second simulation as a branch point to generate additional simulations; identifying a high performing simulation from among the set of simulations and the additional simulations, wherein the high performing simulation is identified based on the at least one optimization goal and by comparing the simulations to the base case performance; developing an actionable retirement plan based on the high performing simulation; and sending the actionable retirement plan to the user.

In some embodiments, the method also includes the step of creating utility functions to improve database performance. Each simulation of the set of simulations can be evaluated year-by-year by executing functions using parameter values for each simulation. The at least one optimization goal can include at least one of: minimized taxes paid, maximized total estate value after tax net of management fees, maximized ending ROTH balance, maximized total cash flow available during a client's lifetime, a maximized account value, and adjusted total return.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWING

FIG. 1 is a flowchart describing methods of developing actionable retirement plans of the inventive subject matter.

FIG. 2 shows how each scenario in a set of scenarios gives rise to multiple sets of simulation parameters.

FIG. 3 shows how each scenario parameter can give rise to multiple possible simulation parameters.

FIG. 4 shows how simulation parameters are selected from the possible simulation parameters for each scenario parameter.

FIG. 5 shows how high performing simulations are discovered for multiple scenarios to develop a set of high performing simulations.

FIG. 6 is a flowchart describing how simulations of the inventive subject matter can be implemented.

### DETAILED DESCRIPTION

The following discussion provides example embodiments of the inventive subject matter. Although each embodiment represents a single combination of inventive elements, the inventive subject matter is considered to include all possible combinations of the disclosed elements. Thus, if one embodiment comprises elements A, B, and C, and a second embodiment comprises elements B and D, then the inventive subject matter is also considered to include other remaining combinations of A, B, C, or D, even if not explicitly disclosed.

As used in the description in this application and throughout the claims that follow, the meaning of “a,” “an,” and “the” includes plural reference unless the context clearly dictates otherwise. Also, as used in the description in this application, the meaning of “in” includes “in” and “on” unless the context clearly dictates otherwise.

It should be noted that any language directed to a computer should be read to include any suitable combination of computing devices, including servers, interfaces, systems, databases, agents, peers, Engines, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network. The following description includes information that may be useful in understanding the present invention. It is not an admission that any of the information provided in this application is prior art or relevant to the presently claimed invention, or that any publication specifically or implicitly referenced is prior art.

Systems and methods of the inventive subject matter are directed to optimizing retirement plans. Optimized retirement plans developed by embodiments of the inventive subject matter consider a variety of initial conditions relating to an individual investor as well as current and future tax laws and policy and market performance among other factors. Generally speaking, an embodiment of the inventive subject matter can be used by a financial planner to develop a plan for a client, though it is contemplated clients can interact with embodiments without the assistance of a financial planner. Thus, a user can be either a financial planner or a client (or both). A client is a person needing an actionable retirement plan, whereas a financial planner is a person responsible for providing a client with an actionable retirement plan.

Embodiments are thus designed to provide detailed retirement plans that are optimized for a given desirable outcome (e.g., a client's stated goal) and based on a client information. Embodiments are designed to generate quantifiable success probabilities of different strategies as a result of simulations that are run on the basis of different scenarios. Embodiments are designed to give users retirement plans that feature, for example, ongoing reporting and strategy adjustment throughout the lifetime of a given retirement plan. Retirement plans can also comply with various standards for performance reporting, such as Global Investment Performance Standards (GIPS).

Retirement plan optimization serves several purposes, including attracting prospects and managing existing client portfolios. For prospective clients, it demonstrates a wealth manager's expertise by providing comprehensive forecasts of potential retirement scenarios. Simulations of the inventive subject matter can be presented through interactive platforms such as dynamic web pages, mobile applications, or detailed PDF reports. Dynamic interfaces empower prospects to explore various outcomes based on different scenarios, illustrating the tangible impact of diverse management strategies on their portfolios.

For existing clients, retirement plan optimization is a versatile tool employed in multiple contexts. Systems can execute simulations at predetermined intervals (e.g., weekly, monthly, quarterly, or annually) or on an ad hoc basis, incorporating the latest account and market data. This approach enables wealth managers to provide clients with up-to-date forecasts on the health and efficacy of their retirement strategy. Simulations can either build on previously considered strategies from prior analyses or generate entirely new strategies (e.g., a de novo approach). Furthermore, simulations can be forward-looking or retrospective, allowing for both future projections and historical “what-if” analyses of alternative management strategies.

A key feature of this optimization system is its ability to juxtapose simulation results against actual market performance. This comparison provides clients with a clear visualization of the real-world effects of recommended retirement strategies. Such transparency serves a crucial dual function: it holds wealth advisors accountable for their portfolio management decisions and provides concrete justification for their fees. By bridging the gap between theoretical projections and actual outcomes, this feature enhances client trust and underscores the value of professional financial guidance in navigating the complexities of retirement planning.

Embodiments of the inventive subject matter can be implemented as downloadable software or as software run on a server or set of servers (e.g., cloud servers) that can be accessible via web browser, software application, and so on. The following discussion is directed to embodiments whereby a platform server (e.g., a cloud server) interacts with a user device (e.g., a user's phone, personal computer, or the like).

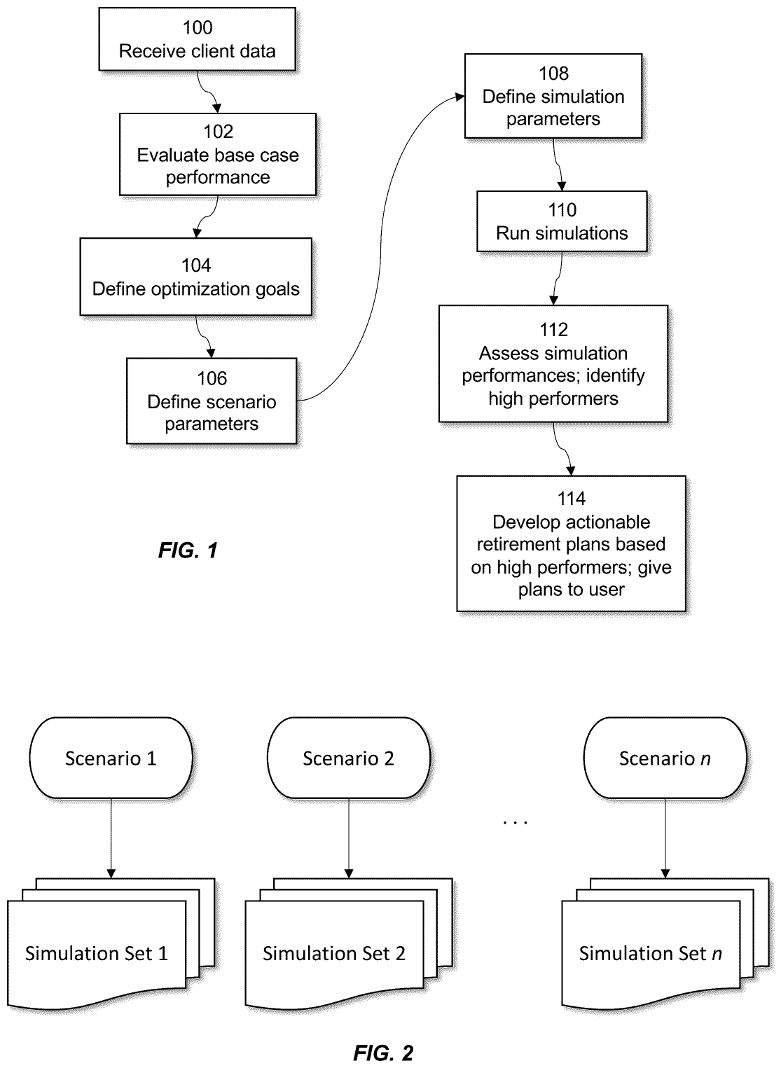

FIG. 1 is a flowchart showing how embodiments of the inventive subject matter can function. In step 100, the platform server receives client information from a user device. To do this, a user sends client information from a user device to a platform server. Thus, in some embodiments, a financial planner can input client information, while in others, a client can input their own client information. Client information can include information relevant to a client's current financial situation, and that client information can be used to generate a retirement plan can be sent from a user device to the platform server.

Client information can include information about a client's financial, health, and circumstantial realities that can be used in creating one or more retirement plans as described in this application. Client information can thus be sent from a user device to the platform server, the client information including assets, incomes, liabilities, etc. Client information can be pertinent not only to current client circumstances but also to future client circumstances, and can include information about a client's expected longevity, health, and so on. Client information can be collected by, e.g., a form, by connecting to third-party software where the data already exists, by parsing the video recording of an onboarding session, and so on.

In some embodiments, demographic information is included in the received client information. For clients that are retired (and their spouses and dependents, where applicable), client information can include marital status, gender, date of birth, age, retirement date, number of dependents, address, state of residence, and so on. Income information can also be collected, including income (e.g., W2, 1099, or any other type of income), pension income, social security amount, passive income, and so on.

Information about a client's expenses can also be collected, including mortgage and other loan information (e.g., student loans, small business loans, credit card debt, etc.). Account information can also be collected. Account information includes cash account current balances, qualified investment account balances, unqualified investment account balances, ROTH balances, IRA balances, planned contributions, planned deferrals, capital gains, and so on.

Client goals can be collected, too. For example, a client's cashflow goals can be input, where cashflow goals can include contemplated purchases or expenses (e.g., houses, cars, travel, etc.), charitable contribution goals, healthcare, and the like. Another type of financial goal can include a desired retirement plan outcome. Desired retirement plan outcomes can include one or any combination of minimized taxes paid, maximized total estate value after tax net of management fees, maximized ending ROTH balance, maximized total cash flow available during a client's lifetime, tax adjusted total return, and so on. Client goals can also include: leaving as much money as possible to children at end of life; minimizing federal and state taxes paid; covering all of retirement expenses through the end of life; maximizing a tax-free (ROTH) account balance; spending the max amount of money possible along the way (e.g., end with zero account balance); maximizing gifting to family during the plan; maximizing amount spent; and maximizing account value. Client goals can be used to optimize scenarios from which simulations can be run, and those scenarios are then used to develop high performing simulations.

Health information can also be included in client information that is received by the platform server. Health information is information that can reasonably be used to determine future healthcare needs, life expectancy, and so on. Health information can include current health conditions, and it can be collected in a number of ways, including by having a client fill out a questionnaire or form, by uploading a doctor's report, by connecting an electronic medical record, by connecting a biometric monitoring device (e.g., an Apple Watch or the like), and so on.

Client information can also include location information. Location information can be used to retrieve localized tax information, which can be relevant for portfolio strategy development. Examples of client information discussed in this application should not be considered comprehensive, as embodiments of the inventive subject matter are adaptable and able to function with whatever information is available.

Per step 102, once client information is received by the platform server, the platform server can use the client information to evaluate base case performance. In evaluating base case performance, the platform server calculates how the client's portfolio will perform year-over-year without any changes to tax or asset strategy, using standard market assumptions, and while accounting for the client's longevity and spending needs. A base case (also referred to as a baseline simulation) does not feature any variations to management strategies and instead operate on a “cruise control,” in a manner of speaking, so that simulations run using different management strategies can later be compared to the base case to assess different management strategies. Assumptions that can be made in evaluating a base case include expected growth of investment account(s), required minimum distribution (RMD) age, social security age, estate tax exemptions by year, spending needs, healthcare needs, expected charitable contributions, investment account locations, and so on.

After evaluating base case performance, several outputs can be generated, including a core scenario data table (e.g., a data frame as discussed in embodiments below), an ending plan performance, a step-by-step plan, and so on. The core scenario data table can include details of what happens on a year-by-year basis, including account balances, spending needs, taxes paid, income, distributions, conversions, and so on. Ending plan performance can include tax adjusted total return, total taxes paid, account locations, cash flow over time, ending estate value, management fees paid, and so on. A step-by-step plan can include detailed instructions on management decisions to make over the course of the portfolio. These instructions can describe what conversions to make each year, how to relocate assets each year (e.g., to minimize tax burden), and so on.

For a base case, a step-by-step investment plan throughout the lifetime of a client's portfolio includes only default actions. In some embodiments, the base case can show changes in performance based on changes in underlying conditions. For example, base case performance may change based on changes in tax rates, RMD amounts, amounts converted from IRA to ROTH, and so on. Upon evaluating base case performance, the platform server can also output a year-by-year accounting of money movements and transactions, year-by-year forecasted tax returns, year-by-year account balances, year-by-year spending needs, life expectancy assumptions, and so on.

Optimization goals are identified according to step 104. Optimization goals can be identified by a user or automatically by the platform server. For example, in some embodiments, the platform server can conclude that, based on age and number of dependents indicated in received client information, that an ending account value may be more important that other factors in maximizing estate value at the end of the conclusion of a retirement plan. In embodiments where the platform server identifies optimization goals automatically, the platform server considers client information it received alongside pertinent financial factors to determine how to optimize an actionable retirement plan for the client. This can involve taking into account a user's stated financial goals that are included with the client information. Factors like age, expected longevity, health, as well as initial conditions of a client's portfolio can all impact how an actionable retirement plan is optimized.

Optimization goals can be defined by a user in the client information that is sent from the user device to the platform server. As mentioned above, users can express a client's desired retirement plan priorities or optimization goals, which can include minimized taxes paid, maximized total estate value after tax net of management fees, maximized ending ROTH balance, maximized total cash flow available during a client's lifetime, and so on. In other words, scenarios can be optimized to achieve one or any combination of the largest estate, the largest ROTH balance, largest net tax liquidation value, largest charitable contribution, specific account location, and so on, based on the goals discussed above and throughout this application.

In step 106, the platform server defines scenario parameters. A scenario of the inventive subject matter describes a set of events and circumstances that are developed using client information to help a client understand the future value of the client's investments given certain differences. Thus, once client information is received, different scenarios having scenario parameters can be defined. For example, one scenario can account for a client's death at age 75, which may be based on that client's current health conditions. Other scenarios can account for a divorce, a second marriage, addition of grandchildren, and so on. At least one scenario must be defined in addition to a base case, such that a basis of comparison exists to evaluate portfolio performance.

Scenario parameters can include management strategies and underlying conditions, all of which can form the basis for developing optimized retirement plans. Some management strategies that can be included as scenario parameters include consideration of account conversion of IRA to ROTH, RMD amounts, and tax synchronization of portfolios (e.g., managing mix of accounts between stocks, bonds, etc. to minimize tax burden). These factors can be considered throughout the simulation. For example, in one simulation an account can be converted from IRA to ROTH in the 10th year, while in another simulation, that event can occur in the 11th year. Simulations can feature differing RMD amounts, as well. Underlying conditions that can impact optimization can include life expectancy ranges for a client, life expectancy ranges for a client's spouse, health expense ranges for a client and/or their spouse, local cost of living, tax law changes (e.g., reversion of Trump era tax laws to Obama era laws), and so on.

In step 108, simulation parameters are defined by the platform server. In general, simulation parameters are based on scenario parameters. Whereas a scenario parameter sets a foundation for different variables that can be adjusted in a simulation, simulation parameters give those variable definite values that are used to run a simulation. Thus, scenario parameters describe variables, and those variables can be given concrete values to facilitate running a simulation, thereby becoming a scenario parameter.

For example, a scenario can include the following scenario parameters:

TABLE 1
Scenario Parameters Examples

| | |
|---|---|
| Spouse 1 life expectancy range | 85-95 years |
| Spouse 2 life expectancy range | 90-97 years |
| Tax Code Possibilities | 2023 tax code or 2017 tax code |
| Social Security Age Range | 72-75 |
| Required Minimum Distribution (RMD) | 72-76 |
| Age Range | |
| Market Performance | 3-9% returns |
| ROTH Conversions | 0-100% |
| Tax Optimized Account Balance | 0-100% |
| Between Stocks and Bonds Range | |

Based on the scenario parameters in Table 1, above, simulation parameters for a simulation could take on the following values based on each scenario parameter:

TABLE 2
Simulation Parameters Examples

| | |
|---|---|
| Spouse 1 age at death | 95 years |
| Spouse 2 age at death | 92 years |
| Tax Code Possibilities | 2023 tax code |
| Social Security Age | Both spouses at 72 years |
| Required Minimum Distribution | Both spouses at 72 years |
| (RMD) Age | |
| Market Performance | 4% returns |
| ROTH Conversions | Fully converted by year 6 |
| | year 1: 50% |
| | year 2: 30% |
| | year 3: 10% |
| | year 4: 5% |
| | year 5: 2.5% |
| | year 6: 2.5% |
| Tax Optimized Account Balance | 70% stocks; 30% bonds |
| Between Stocks and Bonds | |

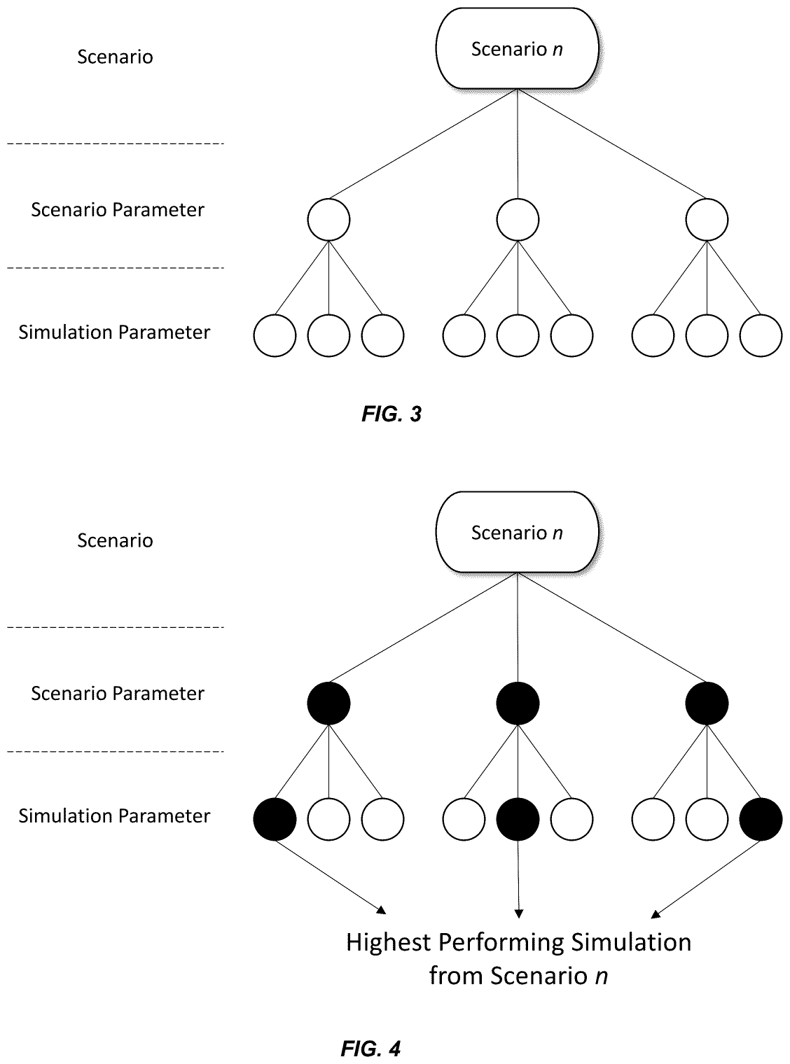

As demonstrated, simulation parameters are selected based on ranges presented by scenario parameters. Thus, simulation parameters can include select values for any scenario parameter in a given scenario, where each scenario parameter defines a range or set of possible values that can be selected for a simulation parameter. FIG. 3 shows a visual example of a scenario having one scenario parameter, which gives rise to multiple simulation parameters. When a scenario has multiple scenario parameters, each giving rise to multiple simulation parameters, the number of simulations that can be run for an individual scenario multiplies. Although three scenario parameters are shown, each having three simulation parameters, the example in FIG. 3 is not limiting in terms of numbers.

In addition to all scenario parameters discussed above, simulation parameters can also include values for: current and future assets and possible changes over time; current and future income and possible changes over time; current and future health and life expectancy and possible changes over time; relationships and dependents and possible changes over time; local economy and cost of living; social security and possible changes over time; healthcare and possible changes over time; current and future state and federal tax law and possible changes over time, and so on.

Simulation parameters can also include a number of simulations to run, an expansion factor between years, a length of performance calculation, and so on. An expansion factor describes how a number of simulations expands based on each selected simulation parameter. For example, if a scenario results in 10 simulations in the first year, then the second year can build off those simulations to create 10 new simulations for each existing simulation, resulting in a total of 100 simulations for the second year. This would be described as an expansion factor of 10. A length of performance calculation refers to a duration of time into the future a set of simulations should be run before determining which simulation is the high performer. In some embodiments, a simulation does not need to run all the way out to the end of a retirement plan because performance can be evaluated effectively once some duration of time (e.g., several years) has been simulated.

A length of performance calculation determines how much time must be simulated before performance can be evaluated. In some embodiments, this duration is manually set, while in other embodiments, the platform server sets this duration based on a review of past simulations to identify how long simulations should run before performance can be effectively evaluated. Setting a length of performance calculation duration can make processing more efficient by eliminating a need to run simulations fully through (e.g., until the end of the retirement plan).

Once scenario and simulation parameters are set, the platform server in step 110 can run each simulation. Each scenario can result in hundreds of different simulations. FIG. 2 shows a visual representation of how scenarios lead to multiple simulations. For example, Scenario 1 leads to simulation set 1, scenario 2 leads to simulation set 2, and scenario n leads to simulation set n, which signifies that up to n number of scenarios can exist, where n is limited by processing power of computing devices or by number of variables available to modify for each scenario or simulation. In other words, a scenario defines boundary conditions upon which simulations can be run. In running sets of simulations on the basis of each different scenario, evolutionary optimization techniques can be implemented to identify high performing simulations for each different scenario. Thus, evolutionary techniques can be used to iteratively converge on a high performing simulation (or set of simulations) that the platform server can then return to the user device. To facilitate evolutionary optimization techniques, hundreds and even thousands of simulations can be run on the basis of each scenario. Evolutionary and other optimization techniques are discussed in more detail, below.

FIG. 4 shows a visualization of a high performing simulation resulting from a single scenario. As shown, each of the three parameters is assigned a value that is used in a simulation. Black circles indicate parameters that are used in the simulation. The end result is that a high performing simulation from the scenario is identified from the set of scenario parameters and resulting simulation parameters. Thus, for scenario n, a high performing simulation is identified, and that high performing simulation can then be compared to high performing simulations that result from a plurality of different scenarios.

It should also be understood that because simulations run over some duration of time, simulation parameters can be changed periodically. For example, simulation parameters can be adjusted each year so that the following year produces simulation results according to different simulation parameters than the previous year. Thus, FIG. 4 can be understood as showing simulation parameters for a specific period of time within the broader context of a full simulation that features multiple time periods (e.g., multiple years).

In step 112, the platform server evaluates each of the simulations run for each scenario to assess performance of the simulations. The base case evaluated in step 102 is used as a basis of comparison to contextualize simulation performance. One or more high performing simulations are used as the basis for developing retirement plans for a user. Optimization goals can be used by the platform server to evaluate how a simulation performs in comparison to a base case. Thus, if a primary optimization goal is to minimize taxes paid, then the simulation that results in the lowest taxes paid relative to a base case is the high performing simulation.

A user can be presented with an interface that shows a set of scenarios with one or more high performing simulations associated therewith. The high performing simulation or simulations can be reformatted into a user-friendly plan that involves actions that take place at various time intervals. A user or client can then select what they believe to be a most likely scenario and then follow one of the optimized simulations resulting from that scenario, where each optimized simulation is reformatted into an actionable retirement plan according to step 114. The platform server can then distribute or otherwise make one or more actionable retirement plans available to a user (e.g., via app, web interface, and so on).

Actionable retirement plans of the inventive subject matter comprise actions that can be taken by a client or on behalf of a client in furtherance of bringing a high performing simulation selected according to the steps described above into the real world. For example, an actionable retirement plan can include steps that can be taken by an advisor, a money manager, a retirement advisor, an accountant, a tax professional, and so on. Steps can also be taken by a business entity, an artificial intelligence implementation, an automated advisor, and so on. In some actionable retirement plans, steps or actions can be carried out by one or any combination of the factors described above.

Steps in an actionable retirement plan can come in a variety of forms, including specific actions and general guidance. For example, a step could require an investment portfolio to be split 60/30 between stocks and bonds without any description of what those stocks are and what those bonds are. In a more specific example, a step could require that, upon reaching a certain year, a specified quantity of money must be converted from an IRA account to a Roth account. Each step corresponds to actions identified via simulation in the steps described above.

When a step features general guidance, that guidance can be related to an actionable retirement plan's optimization goal (or goals, in instances where a plan is optimized for multiple goals). For example, if an actionable retirement plan is optimized to minimize tax burden, then general guidance can be given regarding trading strategies, portfolio mix, tax strategies, spending strategies, healthcare, etc. in furtherance of that goal. The same can be true for any other optimization goal or set of goals.

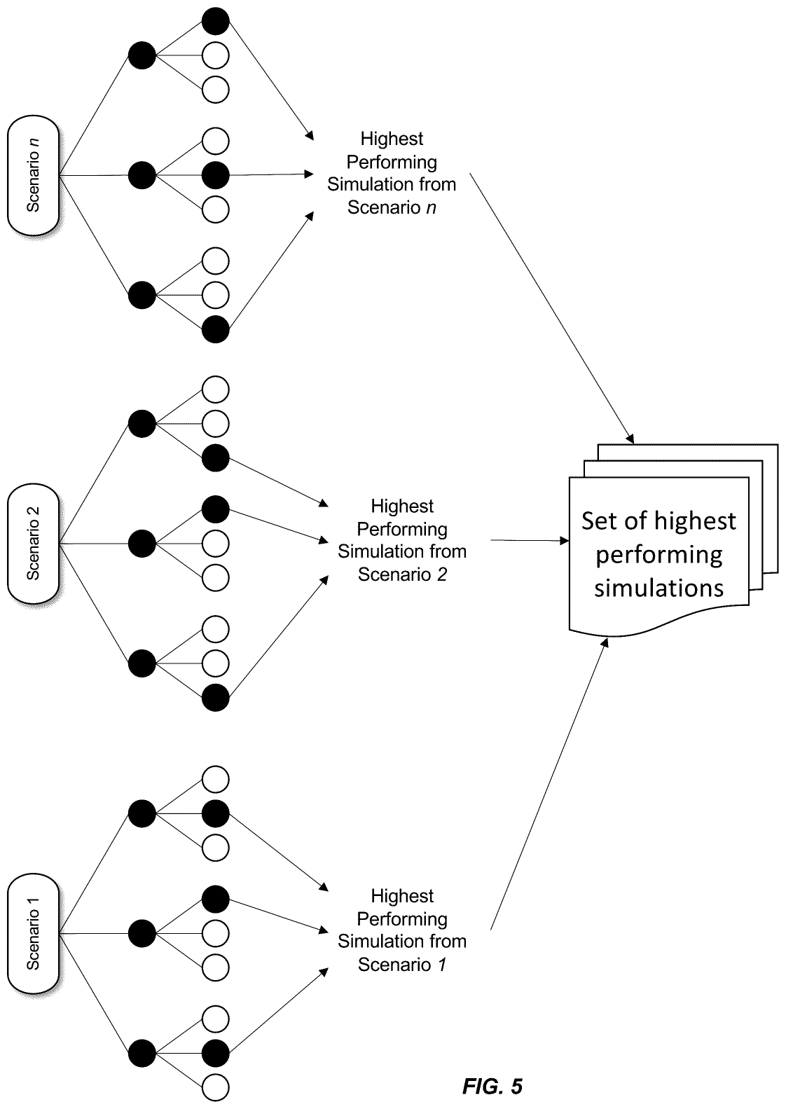

FIG. 5 shows how a set of n scenarios can each result in high performing simulations. Once each scenario is subject to simulation and high performing simulations are identified, each of the high performing simulation can be grouped into a set of high performing simulations and made available to a user.

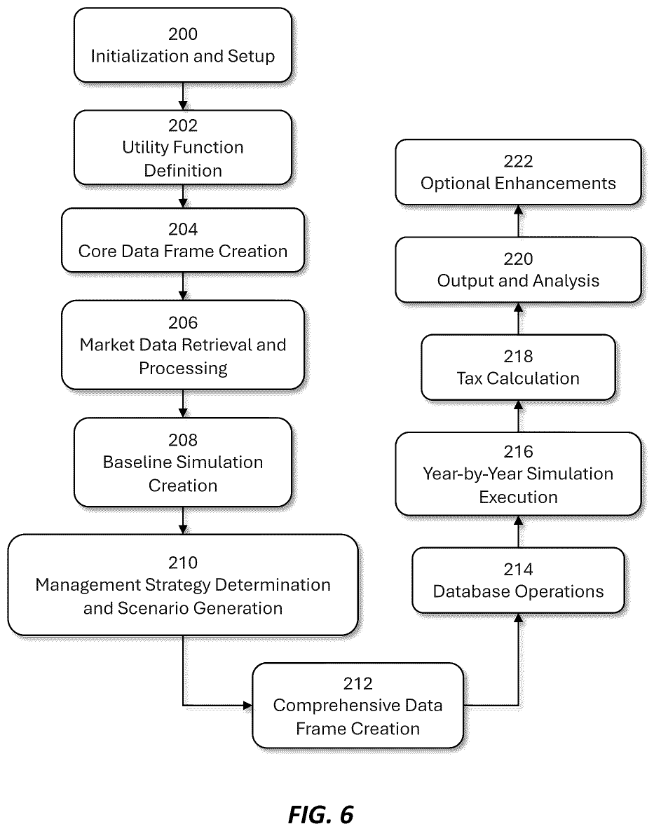

FIG. 6 is a flowchart describing an embodiment of the inventive subject matter that can create and run simulations to develop optimized retirement investment plans. The steps described in FIG. 6 elaborate on the steps described above by providing more detailed information about how those steps can be implemented within a computer environment. It should be understood that in any of the steps shown in FIG. 6 where the platform server is described as taking some action, that the platform server is executing software that brings about that action, and when the platform server is described as receiving some information from a user, that the user has input information on a computing device and sent that information to the platform server, e.g., via network connection.

Step 200 involves initialization and setup. In this step, a user inputs client information into the platform server, sets default values (such as stock and bond indices and other factors that can be used as simulation parameters), and the platform server initializes a database connection. Initializing a database connection typically involves the following steps: importing the database by loading and registering drivers; creating a connection by establishing a connection to the database; creating a statement by preparing a statement for executing queries; executing the query by running the query against the database; and processing the results by handling the results returned by the query. Once that is all completed the connection can be closed and the database connection has been established.

Once the database has been initialized, utility functions can be defined in step 202. Utility functions can be leveraged to improve database performance. For example, helper functions like zero_if_null, zero_if_negative, and calculate_present_value can be defined. In addition, database specific functions and macros that help with database manipulation can be created. High-performing analytical databases are suitable for embodiments of the inventive subject matter. For example, DuckDB can be implemented. DuckDB is an open-source column-oriented relational database management system. In embodiments using DuckDB, functions that are specific to DuckDB can be created and used by the platform server.

For example, a zero_if_null function can be created to replace null, NaN, infinity, or NA values with zero, and a zero_if_negative function can replace negative values with zero. A calculate_rmd_age function can calculate the Required Minimum Distribution age based on birthdate, incorporating recent legislative changes. For example, age 72 for birth years 1950 and earlier, age 73 for birth years 1951-1959, and age 75 for birth years 1960 and later. And a get_age_year function generates a year-by-year age progression from the current year to a maximum age (with a default of, e.g., 95) for either a client or their spouse. Other utility functions can also be created, and the examples in the paragraph do not form a comprehensive list. Utility functions defined in step 202 improve database performance by creating easy to access tools that can be called on as needed.

In step 204, the platform server undertakes core Data Frame creation. During this step, the platform server creates a core Data Frame using, e.g., client demographic data (which has been input during step 200, where the user inputs client information). The core Data Frame serves as the foundation for running simulations described below. A Data Frame is a two-dimensional, size-mutable, and potentially heterogeneous tabular data structure with labeled axes (rows and columns). It is a fundamental data structure in data analysis and is widely used in various data manipulation and analysis tasks. Data Frames can be thought of as a collection of Series objects, which are essentially one-dimensional arrays with labels. Each axis in a Data Frame has a label, which allows for easy identification and manipulation of data. The rows have an index, and the columns have headers. These labels help in accessing and modifying data efficiently. A Data Frame can contain different types of data, such as integers, floats, strings, and even other Data Frames or Series, all within the same structure. This makes it extremely versatile. Data Frames can be expanded or shrunk in size, allowing for dynamic data manipulation; rows and columns can be added or removed as needed. Data Frames support automatic and explicit data alignment, which is crucial for operations involving missing data, and missing data is handled gracefully, often represented as NaN (Not a Number).

Data Frames can be created in several ways, including from lists of dictionaries, dictionaries of Series, 2D NumPy arrays, and reading from external data sources (e.g., CSV, Excel files). For example, creating a Data Frame using a dictionary of lists can be done as follows: ‘“python import pandas as pd data={‘Name’: [‘Alice’, ‘Bob’, ‘Charlie’], ‘Age’: [25, 30, 35], ‘City’: [‘New York’, ‘Los Angeles’, ‘Chicago’]} df=pd.Data Frame (data) print (df)’” This will produce a Data Frame with columns for ‘Name’, ‘Age’, and ‘City’, and rows corresponding to the provided data. Basic operations include selecting data by label or by position (e.g., ‘df [‘Name’]’, ‘df.loc[1]’, ‘df.iloc[1]’), adding or modifying data (e.g., adding a new column with ‘df[‘Salary’]=[70000, 80000, 90000]’ or modifying an existing column with ‘df [‘Age’]=df [‘Age’]+1’), and handling missing data using methods such as filling with a specific value (‘df.fillna(0)’) or dropping rows with missing values (‘df.dropna ( )’).

A Data Frame is an essential data structure for data analysis, providing a flexible and efficient way to store, manipulate, and analyze data. Its ability to handle heterogeneous data, combined with its powerful alignment and missing data handling features, makes it a cornerstone of modern data science. Thus, in embodiments of the inventive subject matter, a core Data Frame is created and populated using client information.

In some embodiments, a create_core function is a central component that facilitates core Data Frame creation. It generates a core Data Frame that serves as a foundation for financial simulations. Key features of a function that creates a core Data Frame are that it: uses client and spouse demographic data; generates year-by-year projections including ages for both client and spouse; incorporates flags for social security eligibility and retirement status; includes tax-related information such as filing status and state; and merges RMD factors based on calculated RMD ages for both client and spouse.

In step 206, market data retrieval and processing takes place. For example, the platform server can retrieve historical price data for stocks and bond indices. This can be done using a function that uses API calls to services that maintain that data. Once market data is retrieved, the platform server can perform several calculations. For example, annual and quarterly stock returns can be calculated and categorized by direction (e.g., positive/negative) and magnitude (e.g., large/small). This same process occurs for bonds, including categorization. The platform server can then create a comprehensive market data structure that includes daily, quarterly, and annual data for both stocks and bonds.

Several functions can be defined to carry out financial calculations. For example, a calc_amount_increase function can calculate a yearly increase of an amount based on inflation, which can be useful for projecting future values of money and of other financial instruments. A process_expense function can process expense data, adjusting for inflation, and it can categorize expenses by type. A process_income function can process income data, adjusting for inflation, and it can categorize income data based on income type (e.g., wages, investment, dividends, etc.) and source (e.g., client or spouse). This function can support multiple income types including ordinary employment, self-employment, unemployment, pension, and social security income. An add_missing_income_columns function can be used to ensure all necessary income columns are present in a Data Frame. Such a function can also add default zero values for missing income types, ensuring comprehensive coverage of all potential income sources.

In step 208, the platform server carries out baseline simulation creation. In this step, multiple simulation baselines can be created simultaneously by leveraging parallel processing techniques. The number of baseline simulations the platform server creates in this step depends on how many baseline simulations are needed as points of comparison. In some embodiments, between 0-10 are needed, while in others 11-50, 51-100, or 101-1000 may be needed. There is no theoretical maximum, and as many baseline simulations as are needed are created to carry out other steps described in this application.

Each baseline simulation involves client information, and each baseline simulation is created as a basis of comparison from which to identify management strategies that are best optimized according to different client goals. Simulations of the inventive subject matter incorporate environmental information (e.g., market movements and so on) that cannot be controlled by a manager, client choices, and portfolio management choices. Baseline simulations are created using only environmental information and, in some embodiments, client choices. Because baseline simulations are intended to give a basis of comparison to find optimized management strategies, baseline simulations do not incorporate any portfolio management choices. Simulations run later do incorporate portfolio management choices, which brings about different end results that can be compared to the baseline simulations to identify high performing simulations based on different management strategies.

For example, the platform server can: process client expenses data, adjusting for inflation; process income data, categorizing by type (e.g., ordinary, self-employment, unemployment, pension, social security, etc.); calculate a difference between income and spending; generate account data for different types (e.g., taxable, tax-deferred, tax-free, HSA); simulate return rates based on historical data and random normal distributions; and calculate year-by-year account balances and return rates. These aspects of client information can be used to generate baseline simulations. A function designed to create each baseline simulation can integrate all processed data (e.g., core data, income, spending, account balances) into a single baseline Data Frame, and it can incorporate Monte Carlo simulation elements by using random normal distributions for market returns. The function can also incorporate multivariate simulation techniques or predictions from machine learning models trained on historical data.

Each baseline Data Frame has the same content as the core Data Frame, but not vice versa (i.e., the baseline Data Frame includes more data than the core Data Frame), and each baseline Data Frame corresponds to different market conditions, and each baseline Data Frame stores an array of different possible management strategies. A baseline Data Frame can then be used to create baseline simulations.

Baseline simulations are created as a means to consider a wide range of possible market conditions. Once baseline simulations are created, a client's goals can then be used to select the best management strategies across all the different market conditions that best satisfy the client's goals. Baseline simulation creation can be executed as a brute force task where many baseline simulations are generated based on many different possible market conditions. Those baseline simulations can later be matched to actual market conditions and used to identify high performing management strategies. In some embodiments, instead of doing brute force baseline simulation generation, optimization techniques can be implemented to more strategically develop baseline simulations. For example, a baseline simulation must go year-by-year to create a baseline simulation that progresses through time, and if a simulation veers too far away from realistic market conditions, then the simulation can be terminated and pruned.

Creating baseline simulations according to step 208 confers several advantages. It facilitates comprehensive market analysis using real-time data (e.g., retrieved by API) to create a nuanced understanding of market behavior, including directional and magnitude-based categorizations. It makes sophisticated income and expense modeling possible by handling various income and expense types with inflation adjustments to give a detailed financial projection. It enables account type differentiation by distinguishing between different account types (e.g., taxable, tax-deferred, tax-free, HSA) and management styles (e.g., managed vs. unmanaged), allowing for nuanced financial strategy development.

In some embodiments, Monte Carlo simulation techniques can be integrated into the step of creating baseline simulations to incorporate random elements in market return projections, which enables risk analysis and multiple market condition evaluations. The resulting baseline Data Frame is thus highly adaptable, allowing for easy integration with other financial modeling tools and further analysis.

Each baseline simulation is created starting with the core Data Frame created above in step 204. Starting with the core Data Frame ensures that necessary client information is incorporated into each simulation. From there, new information and results from calculations can be added to the Data Frame to create a baseline Data Frame. Each baseline Data Frame corresponds to a baseline simulation, and using that baseline Data Frame, the platform server can then generate simulations that use different management strategies to compare to the baseline simulation. Core Data Frames have client information that is true for every simulation (e.g., client age, marital status, etc.), and baseline Data Frames have information that is true for a particular baseline simulation, which allows the platform server to evaluate how different management strategies will work given certain market conditions embodied in the baseline simulation.

In step 210, the platform server develops management strategies and generates simulations that implement those management strategies. Simulations the platform server generates in this step correspond to baseline simulations, except that the simulations in this step implement management strategies to which allows the platform server to identify the highest performing management strategies To identify applicable management strategies, the platform server: checks for Roth conversion applicability (e.g., the presence of tax-deferred accounts); determines asset location strategy applicability (e.g., by checking for multiple account types); assesses charity strategy relevance (e.g., by checking for charitable expenses); and evaluates net unrealized appreciation (NUA) strategy potential (e.g., by checking for employer stock in 401k).

Using those management strategies, the platform server can generate scenario parameters. A generate_conversion_parameters function can be used to create possible Roth conversion parameters. The function generates possible Roth conversion parameters having random conversion amounts over a specified number of years, and it accounts for account growth and ensures total conversions do not exceed 100% of an initial balance, and it includes a no-conversion scenario for comparison.

A generate_asset_location_parameters function can be used to create different asset location parameters. The function generates varying asset blends (e.g., 0%, baseline, and 100%) and it applies these asset blends across simulation years. The platform server can also generate charitable giving parameters (e.g., giving to donor-advised funds and qualified charitable distributions), which can be determined by one or more functions. For example, a calculate_present_value function can calculate the present value of future charitable donations, a calculate_required_daf_amount function can determine the required amount for a Donor Advised Fund (DAF) based on future charitable expenses, a generate_daf_scenarios function creates multiple possible DAF funding parameters, and a generate_charity_parameters function combines possible DAF parameters with Qualified Charitable Distributions (QCDs) parameters, accounting for age restrictions and maximum QCD amounts.

The platform server can also execute a generate_nua_parameters function to create NUA parameters. The function can generate NUA parameters with varying percentages of NUA utilization (e.g., 0%, 25%, 50%, 75%, 100%, and any value therebetween), and these parameters can then be applied across all simulation years.

Next, the platform server generates Roth conversion parameters by creating multiple random Roth conversion parameters and ensuring total conversions do not exceed an initial balance. The platform server can also include a no-Roth-conversion parameter for comparison. The platform server can also create asset allocation parameters with varying asset blends (e.g., 0%, baseline, 100%, and so on) and by applying those asset blends across all simulation years. The platform server can also develop charitable giving parameters by: calculating required Donor-Advised Fund (DAF) amounts; generating DAF funding parameters; and combining DAF parameters with Qualified Charitable Distributions (QCDs) parameters (accounting for age restrictions and maximum QCD amounts). Finally, using the above-described parameters, the platform server can generate NUA parameters with varying percentages of NUA utilization.

Each of these functions generates parameter ranges for scenarios of the inventive subject matter. Then, using those parameter ranges to create scenarios, simulations can be run as described above regarding FIGS. 1-5.

In step 212, the platform server conducts comprehensive Data Frame creation. In this step, the platform server combines all generated parameters (e.g., conversions, asset allocation, charity, NUA, etc.) into a single, comprehensive Data Frame. A comprehensive Data Frame is joined with baseline simulation data, and the platform server initializes additional financial metrics (e.g., HSA balances, RMD amounts, account balances by type and asset class, and so on). Finally, the platform server prepares tax-related fields for future calculations.

In step 214, the platform server conducts database operations, like writing the comprehensive Data Frame to the database, creating necessary database structures and indexes, and adding columns for total assets under management (AUM), advisor fee expenses, and total yearly expenses.

With steps 200 through 214 completed, in step 216, the platform server can undertake year-by-year simulation execution, where each simulation is based on a scenario with a set of assigned values as described above, where each scenario is stored as a comprehensive Data Frame and having an associated baseline simulation to which simulations stemming from the scenario can be compared. For each year in the simulation period, the platform server performs a set of tasks, including: updating account balances, calculating RMDs and QCDs, subtracting healthcare spending, calculating advisor fee expenses, subtracting remaining spending, processing Roth conversions, initiating accounts for asset allocation, growing accounts, rebalancing accounts, calculating capital gains dividends, and preparing tax variables.

In addition to these parameters, simulations can incorporate management fees. Typically, financial advisors, fund managers, and the like charge based on the total amount of dollars under their management across all managed accounts. accounts under management, and then the managers are paid according to some percent of that amount (e.g., anyway from a few tenths of a percent up to 2%). Fees are withdrawn from client accounts. Embodiments of the inventive subject matter can simulate retirement plans that factor in management fees, which results in a better optimized retirement plan.

To update account balances, the platform server updates beginning balances for taxable, tax-deferred, and tax-free accounts, it updates HSA balances, and it calculates prior year taxes. To calculate RMDs and QCDs, the platform server determines RMD amounts for tax-deferred accounts, applies any applicable QCDs, and adjusts account balances accordingly. To carry out these tasks, the platform server can execute one or more functions. For example, an update_account_balances function can be used to update account balances at the beginning of each year for various account types (e.g., taxable, tax-deferred, tax-free) for both client and spouse, and a calculate_rmds_and_qcds function can be used to calculate Required Minimum Distributions (RMDs) and Qualified Charitable Distributions (QCDs) for retirement accounts.

To subtract healthcare spending, the platform server uses health income first, then uses any available HSA funds, and applies any remaining expenses to other income and account types following a specific cascade. To calculate advisor fee expense, the platform server determines total AUM and applies tiered fee structure based on AUM. To subtract remaining spending, the platform server calculates total expenses for the year and applies expenses to various income sources and account types following a specific hierarchy. The platform server can execute one or more functions to carry out these tasks. For example, a subtract_healthcare_spending function can be configured to manage healthcare expenses by prioritizing spending from different account types. A subtract_remaining_spending can handle remaining expenses after healthcare by following a specific spending cascade. And a subtract_roth_conversions function can process Roth conversion amounts by adjusting balances in tax-deferred and tax-free accounts.

To process Roth conversions, the platform server applies conversion amounts to tax-deferred accounts and increases tax-free account balances accordingly. To initiate accounts for asset allocation, the platform server sets initial asset allocations for each account type based on a selected strategy. To grow accounts, the platform server applies simulated market returns to account balances. To rebalance accounts, the platform server adjusts asset allocations based on a selected strategy and calculates rebalancing amounts for each account type. The platform server can execute one or more different functions to bring about these actions. For example, an initiate_accounts function can set up initial account balances and asset allocations. A grow_accounts function can simulate growth of different account types based on market returns. And a rebalance_accounts function can implement asset rebalancing strategies across different account types.

To calculate capital gains and dividends, the platform server estimates capital gains from rebalancing and withdrawals, and it calculates dividend income. To prepare tax variables, the platform server maps financial data to an input format that is compatible with tax simulation software (e.g., TAXSIM) and it prepares all necessary variables for tax calculation. The platform server can execute one or more functions to prepare data for tax calculations using tax simulation software such as TAXSIM. Using TAXSIM as an example, a taxsim_state_index function can create a mapping between state abbreviations and TAXSIM state codes, a return_taxsim_state function can convert a state abbreviation to its corresponding TAXSIM state code, and a return_taxsim_Data Frame can generate a template Data Frame with all required fields for TAXSIM calculations.

The platform server can execute one or more functions to calculate capital gains, dividends, and tax-related quantities. For example, a calc_cap_gains_and_dividends function can calculate capital gains and dividends for taxable accounts, and a calc_tax_variables function can prepare variables for tax calculations by mapping client information to tax simulation software input format.

Each of these functions can be called while evaluating simulations. To determine simulation performance and how that performance changes year by year, these functions are called over and over to calculate aspects of a client's portfolio as a simulation progresses. Ultimately, simulation performance is evaluated based on the results of these functions because at the end of a simulation, these functions are what determine how a management strategy has performed. Thus, final simulation results are generated and stored to the database.

Throughout the process of evaluating simulation performance year-by-year, simulation optimization can be incorporated. For example, if a simulation reaches a particular year (any year) and it becomes clear that some aspect of the simulation makes that simulation nonviable (e.g., some aspect of the simulation becomes invalid, or some aspect of the simulation becomes implausible), then that simulation can be pruned. Other simulations that result in more-likely-to-be-viable results (e.g., preliminarily high performing simulations) at some year before those simulations have concluded can then be used as branching points to generate additional simulations that are variants of those more-likely-to-be-viable partial simulations. In other words, the additional simulations use the preliminarily high performing simulations to define their initial conditions. High performing simulations can ultimately exist among the additional simulations or among the original set of simulations. In some embodiments, the additional simulations are added back into the original set of simulations.

At this stage, the steps described in relation to FIG. 6 have conferred several advantages. For example, the platform server has implemented Monte Carlo-style Roth conversion modeling by generating random Roth conversion parameters, allowing for risk analysis and optimization. It has set the stage for integrated charity planning by combining DAF strategies with QCD strategies to optimize tax efficiency of charitable giving. Flexible asset allocation modelling allows for the evaluation of different asset allocation strategies across account types. NUA strategy evaluation incorporates net unrealized appreciation scenarios to create sophisticated tax strategies for employer stock in retirement plans. And tax-aware modeling prepares data for detailed tax calculations using the tax simulation software to ensure accurate after-tax projections.

The platform server can execute several other functions during this step, including an update_year function that orchestrates the yearly update process by calling various functions in sequence, and a run_taxes_by_year function that tax calculations for a specific year using a tax simulation software model and updates the database with results.

With year-by-year simulations executed, tax calculations can be completed per step 218. To perform tax calculations, the platform server, for each year: prepares data for tax simulation software; executes tax calculations using the tax simulation software; retrieves tax results (e.g., federal and state income tax, FICA, tax rates); and updates the database with tax results.

Throughout the steps described in relation to FIG. 6, a variety of optimization techniques can be implemented. For efficient data manipulation, the platform server can use, e.g., data.table, and it can implement parallel processing for computationally intensive tasks (e.g., baseline simulation generation). Database usage can also be optimized by, e.g., creating appropriate indexes, using prepared statements for repeated queries, leveraging vectorized execution capabilities (while using databases that support vectorized execution, like DuckDB), utilizing parallel query execution, implementing bulk insert operations, adjusting memory settings based on available system resources, employing vectorized operations where possible (e.g., in R), and using efficient data structures (e.g., bit64::integer64 for large integers).

Simulations of the inventive subject matter can also be subject to optimization techniques including evolutionary solution development, gradient descent, and particle swarm optimization, which can all be used to zero in on optimized retirements and management strategies that should be implemented to achieve a client's goal or goals.

Gradient descent is a fundamental optimization algorithm widely used in machine learning and artificial intelligence. It is particularly instrumental in training models by minimizing error functions and improving prediction accuracy. Gradient descent works by iteratively adjusting the parameters of a model to reduce the value of a cost function, which measures the difference between predicted and actual values.

A gradient is a vector that points in the direction of the steepest ascent of a function at a given point. In the context of optimization, gradients indicate how to adjust parameters to decrease the cost function. The magnitude of the gradient tells us how significant the change should be.

To implement a gradient descent algorithm, the following steps can be implemented. First, parameters are initialized by starting with random values for the parameters that need to be optimized. Next, the gradient is computed by calculating the gradient of the cost function with respect to each parameter. Parameters are then updated by adjusting the parameters in the opposite direction of the gradient to reduce the cost function. This step is controlled by a learning rate, which determines the size of each adjustment. These steps are iteratively repeated until the cost function converges to a minimum value or the change in the cost function falls below a predefined threshold. In the context of an embodiment of the inventive subject matter, when the cost function falls below a predefined threshold, it indicates that a corresponding client goal has been optimized.

There are several variations of gradient descent, each with its unique characteristics and use cases. Batch gradient descent involves computing the gradient using the entire dataset. While this approach is accurate, it can be computationally expensive and slow for large datasets. Stochastic gradient descent (SGD) computes the gradient using a single data point at a time. This approach is faster and can handle large datasets efficiently, but it introduces more noise into the optimization process. Mini-batch gradient descent strikes a balance between batch gradient descent and SGD by computing the gradient using a small subset of the dataset. This approach combines the benefits of both accuracy and efficiency.

Gradient descent is used in various fields and applications, including linear regression, logistic regression, neural networks, and recommendation systems. In a linear regression, gradient descent is used to optimize the parameters of the linear model to minimize the mean squared error between predicted and actual values. In a logistic regression, gradient descent is used to adjust the parameters of the logistic model to maximize the likelihood of correctly classifying data points. With neural networks, gradient descent is used to fine-tunes the weights and biases of neural networks to reduce the error in predictions. This process is known as backpropagation. In recommendation systems, gradient descent is used to improves the accuracy of recommendations by optimizing the parameters of collaborative filtering models.

While gradient descent is a powerful optimization tool, it comes with its challenges. Selecting an appropriate learning rate is crucial. A rate that is too high can cause the algorithm to overshoot the minimum, while a rate that is too low can make the convergence slow. Gradient descent can also get stuck in local minima or saddle points, leading to suboptimal solutions. Techniques like momentum and adaptive learning rates can help mitigate this issue. And for large datasets, computing gradients can be expensive. Mini-batch gradient descent helps alleviate this problem but requires careful tuning of batch sizes.

Particle Swarm Optimization (PSO) is a computational method inspired by the social behavior of birds flocking or fish schooling. It is widely used for finding optimal solutions to complex problems in various fields, including engineering, economics, and artificial intelligence. PSO simulates the movements of a swarm of particles, each representing a potential solution to the optimization problem. These particles “fly” through the solution space by following simple mathematical rules that are influenced by their own experience and the experience of neighboring particles. Each particle represents a candidate solution to the problem. It has a position in the solution space, a velocity, and a memory of its best position found so far. The velocity of a particle determines its direction and speed of movement through the solution space. It is influenced by three factors: inertia, the particle's tendency to continue moving in its current direction; the cognitive component, which is the influence of the particle's personal best position; and the social component, which is the influence of the best position found by the swarm.

Each iteration, particles update their velocities based on these factors and move to new positions. The new position is calculated by adding the velocity to the current position. The “global best” is the best position found by any particle in the entire swarm. The “local best” is the best position found by any particle in a neighborhood of particles. Particles update their velocities and positions based on these bests to find the optimal solution.

PSO is simple to implement and requires few parameters to adjust. It is robust, capable of handling a wide range of optimization problems, both continuous and discrete. PSO tends to converge quickly to a good solution, making it suitable for real-time applications. Additionally, it can be easily modified and hybridized with other optimization techniques to enhance performance.

PSO is applied in various domains due to its versatility and efficiency. It is used in optimizing the design of mechanical structures, electrical circuits, and other engineering systems to achieve desired performance characteristics. In machine learning, PSO helps in training models by optimizing hyperparameters and weights to improve model accuracy and performance. In robotics, PSO is used for path planning, control optimization, and swarm robotics, where multiple robots coordinate to achieve a common goal. In the context of embodiments of the inventive subject matter, PSO can be employed in financial modeling for portfolio optimization, asset allocation, and other financial models to maximize returns and minimize risks. In step 220, the platform server generates output and analysis. In this step, the platform server retrieves final simulation results from the database, where the final simulation results retrieved correspond to a simulation that was high performing in view of a client's optimization goal. It then performs any final calculations or aggregations, prepares summary statistics across all scenarios, and it generates visualizations of key metrics over time. In this step, the platform server generates an actionable retirement plan based on the final simulation.

Finally, in step 222, the platform server carries out any optional enhancements. Optional enhancements include: implementing more sophisticated asset allocation strategies (e.g., glide paths); incorporating additional financial products or strategies (e.g., annuities, life insurance); developing more detailed tax optimization techniques (e.g., tax-loss harvesting); creating sensitivity analysis for key parameters; developing Monte Carlo simulations for market returns; and implementing machine learning algorithms for strategy optimization; and creating a user interface for input and result visualization.

Embodiments of the inventive subject matter give rise to a number of innovations, including dynamic RMD age calculation, flexible spouse handling, comprehensive time series generation, integration of multiple data sources, and efficient data processing while handling potentially massive numbers of simulations.

For dynamic RMD age calculation, embodiments adapt to recent changes in RMD regulations, automatically determining the correct RMD age based on birthday. For flexible spouse handling, embodiments accommodate both single and married filing scenarios, dynamically adjusting calculations based on filing status. For comprehensive time series generation, embodiments create a year-by-year projection that forms the basis for complex financial simulations. To integrate multiple data sources, embodiments combine demographic data, tax information, and RMD factors into a unified Data Frame. Finally, embodiments improve data processing efficiency by, e.g., using modern R libraries for high performance data manipulation, which are crucial for handling large datasets in financial simulations. For example, out of memory data processing, parallel processing, and using vectorized functions can all improve data processing efficiency in embodiments of the inventive subject matter.

At this stage in the steps, the method has given rise to numerous additional advantages. For example, it has facilitated integrating various aspects of personal finance including retirement accounts, healthcare spending, asset growth, and tax implications to create comprehensive financial simulations. It has facilitated dynamic asset allocation by implementing sophisticated rebalancing strategies that can adapt to different market conditions and personal preferences. It has facilitated tax-aware planning by incorporating detailed tax calculations using a tax simulation software model by allowing for accurate after-tax projections and optimization of tax strategies. It has a facilitated flexible spending hierarchy by implementing a customizable spending cascade that prioritizes withdrawals from different account types based on tax efficiency. It has facilitated RMD and QCD integration by automatically calculating and applying Required Minimum Distributions and Qualified Charitable Distributions by ensuring compliance with retirement account regulations. It has facilitated scalable database operations by using a high-performance database (e.g., DuckDB) for efficient in-memory processing of large datasets that allows for rapid simulation of multiple scenarios.

It should be understood that steps and aspects discussion in relation to FIG. 6 expand on those steps and aspects discussed elsewhere in this application, and vice versa. FIG. 6 provides more details on how methods of the inventive subject matter can be implemented in practice, and thus aspects discussed in the context of FIG. 6 can be applied elsewhere in this application. Similarly, aspects and steps discussed in relation to FIGS. 1-5 can be imported into FIG. 6 without deviating from the inventive subject matter.

Thus, specific systems and methods directed to retirement plan optimization have been disclosed. It should be apparent, however, to those skilled in the art that many more modifications besides those already described are possible without departing from the inventive concepts in this application. The inventive subject matter, therefore, is not to be restricted except in the spirit of the disclosure. Moreover, in interpreting the disclosure all terms should be interpreted in the broadest possible manner consistent with the context. In particular the terms “comprises” and “comprising” should be interpreted as referring to the elements, components, or steps in a non-exclusive manner, indicating that the referenced elements, components, or steps can be present, or utilized, or combined with other elements, components, or steps that are not expressly referenced.

What is claimed is:

1. A method of developing an optimized retirement plan, the method comprising the steps of:
receiving, at a platform server from a user, client information comprising income data and a client optimization goal;
creating a core data frame using the client information;
creating a baseline data frame using the core data frame, wherein the baseline data frame comprises client information and wherein the baseline data frame is used to generate a baseline simulation;
creating a comprehensive data frame using the baseline simulation;
generating a set of simulations using the comprehensive data frame;
using the client optimization goal to evaluate simulation performance by comparing each simulation in the set of simulations to the baseline simulation in view of the client optimization goal;
identifying a simulation from the set of simulations as high performing;
developing an actionable retirement plan based on the simulation; and
sending the actionable retirement plan to the user.

2. The method of claim 1, further comprising the step of creating utility functions to improve database performance.

3. The method of claim 1, wherein the comprehensive data frame comprises a set of scenario parameters comprising a plurality of possible values.

4. The method of claim 3, wherein each simulation of the set of simulations is evaluated year-by-year by executing functions using parameter values for each simulation.

5. The method of claim 1, wherein the optimization goal comprises at least one of: minimized taxes paid, maximized total estate value after tax net of management fees, maximized ending ROTH balance, maximized total cash flow available during a client's lifetime, a maximized account value, and adjusted total return.

6. A method of developing an optimized retirement plan, the method comprising the steps of:
initializing a database;
defining utility functions to improve database performance;
receiving, at a platform server from a user, client information comprising at least one optimization goal;
evaluating a base case performance using the client information;
defining a set of scenarios, each scenario comprising a set of scenario parameters;
defining sets of simulation parameters for each scenario in the set of scenarios;
wherein each set of simulation parameters comprises values for scenario parameters defined using a single set of scenario parameters;
generating a set of simulations using each set of simulation parameters;
identifying a first simulation in the set of simulations as a nonviable simulation and pruning the nonviable simulation;
identifying a second simulation in the set of simulations as a preliminarily high performing simulation and using the second simulation as a branch point to generate additional simulations;
identifying a high performing simulation from among the set of simulations and the additional simulations, wherein the high performing simulation is identified based on the at least one optimization goal and by comparing the simulations to the base case performance;
developing an actionable retirement plan based on the high performing simulation; and
sending the actionable retirement plan to the user.

7. The method of claim 6, further comprising the step of creating utility functions to improve database performance.

8. The method of claim 6, wherein each simulation of the set of simulations is evaluated year-by-year by executing functions using parameter values for each simulation.

9. The method of claim 6, wherein the at least one optimization goal comprises at least one of: minimized taxes paid, maximized total estate value after tax net of management fees, maximized ending ROTH balance, maximized total cash flow available during a client's lifetime, a maximized account value, and adjusted total return.
